(19) United States
(12) Patent Application Publication
(10) Pub. No.: US 2022/0170382 A1
(43) Pub. Date: Jun. 2, 2022

(54) SHAFT FAILURE PROTECTION SYSTEM

(71) Applicant: Rolls-Royce Deutschland Ltd & Co KG, Blankenfelde-Mahlow (DE)

(72) Inventor: Jorge CALDERON, Berlin (DE)

(21) Appl. No.: 17/535,620

(22) Filed: Nov. 25, 2021

(30) Foreign Application Priority Data
Nov. 27, 2020 (EP) 20210341.2

(51) Int. Cl. F01D 21/00

(52) U.S. Cl. CPC F01D 21/006; F05D 2260/902; F05D 2300/516; F05D 2300/603; F05D 2220/32; F05D 2230/90

(57) ABSTRACT

A shaft failure protection system includes an engine core comprising a turbine, a compressor, and a shaft connecting the turbine and compressor; a first braking element connected to a rotating part of the turbine; and a second braking element connected to a static part of the turbine. The first and second braking elements are arranged at an axial distance under normal operating conditions and configured to contact each other in case of a failure of the shaft and an associated axial displacement of the rotating part. The first braking element includes a first friction material and the second braking element comprises a second friction material, wherein the first and second friction materials each comprise a carbon-silica composite or a carbon-fibre-reinforced carbon. Upon shaft failure and associated axial displacement of the rotating part, the first and second friction materials contact each other to reduce speed of the rotating part.

### This application claims priority to European Patent Application EP20210341.2 filed Nov. 27, 2020, the entirety of which is incorporated by reference herein.

The present disclosure relates to a shaft failure protection system.

A gas turbine comprises a compressor, a combustion chamber and a turbine. Depending on the type of gas turbine, several compressors and turbines can be provided, for example a low-pressure compressor and a high-pressure compressor as well as a low-pressure turbine and a high-pressure turbine. The turbine is driven by combustion gases from the combustion chamber and in turn drives the compressor via a shaft. For example, a low-pressure turbine drives a low-pressure compressor via a low-pressure shaft and a high-pressure turbine drives a high-pressure compressor via a high-pressure shaft.

In the event of a shaft break in a gas turbine, the turbine is suddenly separated from the compressor. At the same time, the compressor continues to deliver mass flow for a certain time, which accelerates the turbine. In the event of shaft breakage, accordingly, there is a risk that the now free-running turbine will be accelerated beyond its maximum permissible speed (the so-called “terminal speed”) and that a disk break will occur.

The terminal speed is calculated through a Transient Performance Assessment. This assessment models a shaft failure event and predicts the terminal speed based on the performance modelling of the engine. This assessment also includes in its modelling characteristics of the shaft failure event outside of the gas path performance such as frictional forces between the turbine and the adjacent static structures.

US 2009/0126336 A1 discloses a shaft failure protection system which implements a braking device which comprises a first braking member provided with an abrasive element in the form of abrasive granules in particular of ceramic material or zirconium, and a second braking member comprising a ring-shaped element made of a material capable of being eroded by the abrasive element, wherein one braking member is secured to the rotor and the other braking member is secured to the stator. The braking members come into contact with one another through axial displacement of the rotor once the shaft is broken, the abrasive element of the first braking member eroding the ring-shaped element of the second braking member.

In a similar manner, US 2020/0200037 A1 discloses a shaft failure protection system that includes two friction decelerators, one decelerator being located between stages of a low-pressure turbine and the other decelerator being located adjacent to a static structure. In the event of a shaft break, respective portions of the low-pressure turbine move axially into contact with the friction decelerators.

The problem underlying the present invention is to provide for a shaft failure protection system that provides for an efficient braking effect in case of a shaft failure.

The invention provides for a shaft failure protection system with the features of claim 1. Embodiments of the invention are identified in the dependent claims.

According to an aspect of the invention, a shaft failure protection system is provided that comprises an engine core with a turbine, a compressor, and a shaft connecting the turbine and the compressor. A first braking element is connected to a rotating part of the turbine and a second braking element is connected to a static part of the turbine. The first braking element and the second braking element are arranged at an axial distance under normal operating conditions and configured to contact each other in case of a failure of the shaft and an associated axial displacement of the rotating part of turbine.

It is provided that the first braking element comprises a first friction material and the second braking element comprises a second friction material, wherein the first friction material and the second friction material each comprise a carbon-silica composite or a carbon-fibre-reinforced carbon. In case of a failure of the shaft and an associated axial displacement of the rotating part of the turbine, the first friction material and the second friction material contact each other to reduce rotational speed of the rotating part of the turbine by frictional forces.

Aspects of the invention are thus based on the idea to implement as friction material of the first braking element and of the second braking element a carbon-silica composite or a carbon-fibre-reinforced carbon. By providing such friction material, the frictional forces between the first braking element and the second braking element in case of a shaft failure are substantially increased compared to a metal-to-metal contact between a rotating part and a static part of the turbine as occurs in prior art gas turbine engines. In particular, the frictional forces may be increased by an order of magnitude and more compared to frictional forces in case of a metal-to-metal contact.

By providing increased frictional forces, in case of a shaft failure more kinetic energy is dissipated by the first and second braking elements such that the rotational speed of the rotating part of the turbine is reduced and limited to a value below the maximum permissible (terminal) speed. Accordingly, it can be guaranteed that the rotating part of the turbine, in particular the turbine disc can sustain the rotational speed occurring during a shaft failure event. As a result, the turbine discs can be designed for a lower maximum speed. Weight and costs can thus be saved. A more compact turbine architecture with lower weight can be created.

Another advantage associated with the invention lies in that carbon-silica composite and carbon-fiber-reinforced carbon materials are capable of withstanding high temperatures as present in a turbine environment and extract high levels of energy. On the other hand, without the invention, in case of a metal-to-metal contact, the metal melts during braking operation, thereby further decreasing the frictional forces.

A still further advantage associated with the invention lies in that a carbon-silica composite material or a carbon-fibre-reinforced carbon material has a relatively low density such that it is lightweight and, accordingly, favourable to implement in an aircraft gas turbine engine.

It is pointed out that the configuration of the turbine is such that, in case of a shaft failure, the rotating part of the turbine is not constrained to move in an axial direction. This condition is typically met when a rear bearing of the shaft is a roller bearing that constrains movement of the shaft in the radial direction only but does not constrain movement of the shaft in the axial direction. Axial movement of the rotating part of the turbine in case of a shaft failure is caused by an axial force created by the main gas path on the turbine elements and also by forces created by a secondary air system.

As to terminology, it is pointed out that a carbon-silica composite may be any composite which comprises as constituent materials on the one hand a carbon-based material and on the other hand a silicon-based material. Examples for the carbon-based material are carbon, carbon fibers, or carbon fiber reinforced carbon. Examples for the silicon-based material are silicon and silicon carbide (SiC).

In an embodiment of the present invention, the carbon-silica composite is a carbon fibre reinforced silicon carbide (C/SiC), wherein carbon fibres are integrated in a silicon carbide (SiC) matrix. Carbon fiber reinforced silicon carbide is a very strong composite made of a silicon carbide matrix with carbon fiber reinforcement. Carbon fiber reinforced silicon carbide is a known material which is manufactured, e.g., by the company SGL Carbon SE in DE-65201 Wiesbaden. The exact technical properties of such material may be adjusted by the type, in particular the percentage and length, of the carbon fibers.

Alternatively, carbon-fibre-reinforced carbon (C/C) which is a composite material consisting of carbon fibre reinforcement in a matrix of graphite may be used as material of the first and second braking elements. Carbon-fibre-reinforced carbon (C/C) is less durable than carbon fibre reinforced silicon carbide (C/SiC) but is of less weight. Carbon fibre reinforced silicon carbide (C/SiC) is a ceramic composite material that has properties that combine the properties of carbon-fibre-reinforced carbon (C/C) and polycrystalline silicon carbide ceramics.

In an embodiment, the first friction material of the first braking element and the second friction material of the second braking element are chosen such that the coefficient of kinetic friction between these materials is in the range between 0.15 and 0.8, in particular in the range between 0.4 and 0.6. This is an increase over a kinetic friction coefficient of about 0.06 which is present in case of metal-to-metal friction. As coefficient of friction the coefficient of kinetic friction is considered, also referred to as the coefficient of dynamic friction. It is defined as the ratio of the force of friction between two bodies and the force pressing them together, wherein, in case of the kinetic friction coefficient, two bodies in relative motion are considered. This is appropriate as the coefficient of kinetic friction obviously is relevant when the braking element connected to the rotating part and the braking element connected to the static part mate with each other.

Further, the coefficient of friction is considered at operating temperature, i.e., the temperature of the first and second braking elements during operation of the gas turbine engine. The operating temperature range, in an embodiment, is between 500° C. and 1300° C., wherein 500° Celsius represents an upper range of the temperature of the braking elements without braking activity, i.e., caused by the temperature of the environment in which the braking elements are placed, and wherein 1300° C. represents an upper range of the temperature of the braking elements during braking operation, when with the braking elements heat up caused by the braking operation. Accordingly, in an embodiment, the operating temperature is 500° C. In another embodiment, the operating temperature is 1300° C. Carbon-silica composite materials and carbon-fiber-reinforced carbon materials have a high friction coefficient in the temperature range between 500° C. and 1300° C.

It is pointed out that during a braking operation, when the first and second braking elements are in contact, the heat generated at the contacting surface is conducted to the adjacent material of the braking elements which acts as a heat sink, thereby limiting the temperature. In this respect, carbon-silica composite and carbon-fiber-reinforced carbon materials have good heat absorption properties.

According to an embodiment, the first friction material and the second friction material are identical. Accordingly, the first and second braking elements may be formed by the same material. However, alternatively, different carbon-silica composites may be used for the first friction material and the second friction material.

In an embodiment, the rotating part of the turbine is a rotor disc, wherein the first braking element is connected to a sealing element structure coupled to the rotor disc. Alternatively, e.g., the first braking element is directly connected to a rotor disc. The static part of the turbine to which the second braking element is connected may be coupled to a bearing structure for the shaft. Other embodiments are possible as well as long as one braking element is coupled to a rotating part of the turbine and the other braking element is coupled to a static part of the turbine.

In an embodiment, the first and second braking elements that comprise or consist of the first and second friction material each comprise a surface, the surfaces interacting with each other in case of a shaft failure. In particular, such surface may be a flat surface. Interaction by means of flat surfaces is highly efficient for creating frictional forces that reduce the rotational speed of the rotor. However, other forms of the two mating surfaces of the first and second braking elements are possible as well, e.g., concave and convex surfaces, respectively.

In an embodiment, the surface of the first friction material and/or the surface of the second friction material which contact each other in case of a shaft failure have undergone a surface treatment that has increased the roughness of the surface compared to a prior state of manufacture. This may imply that the contacting surface comprises a roughness that is higher than the roughness of other of the surfaces of the respective braking element. Such surface treatment may include chemical treatment or laser treatment. For example, by means of a laser a grid of small structures may be formed on each of the surfaces of the first friction material and the second friction material, wherein in the respective structures interact under increased frictional forces in case of a shaft failure.

In a further embodiment, first braking element and/or the second braking elements is in the form of a ring, the ring being formed in the circumferential direction of the gas turbine engine. In particular, it may be provided for that both the first braking element and the second braking element are in the form of a ring such that a maximum surface that experiences frictional forces is provided for between the first braking element and the second braking element.

The system may be implemented in a high-pressure turbine and/or a low-pressure turbine of the gas turbine engine. In particular, it may be implemented in the high-pressure turbine as the high-pressure turbine is typically not constrained to move axially when a shaft failure occurs. Also, the high-pressure turbine experiences a particularly high rotational speed.

In a further aspect, the present invention regards a gas turbine engine for an aircraft that comprises a system in accordance with the present invention. In particular, the gas turbine engine may comprise:
an engine core comprising a turbine, a compressor, and a core shaft connecting the turbine to the compressor,
a fan located upstream of the engine core, the fan comprising a plurality of fan blades; and
a gearbox that receives an input from the core shaft and outputs drive to the fan so as to drive the fan at a lower rotational speed than the core shaft.

The turbine is a first turbine, the compressor is a first compressor, and the core shaft is a first core shaft. The engine core further comprises a second turbine, a second compressor, and a second core shaft connecting the second turbine to the second compressor, wherein the second turbine, second compressor, and second core shaft are arranged to rotate at a higher rotational speed than the first core shaft. The system in accordance with the present invention may be implemented in the second turbine, which is the high-pressure turbine, and/or the first turbine, which is the low-pressure turbine.

The invention will be explained in more detail on the basis of exemplary embodiments with reference to the accompanying drawings in which:

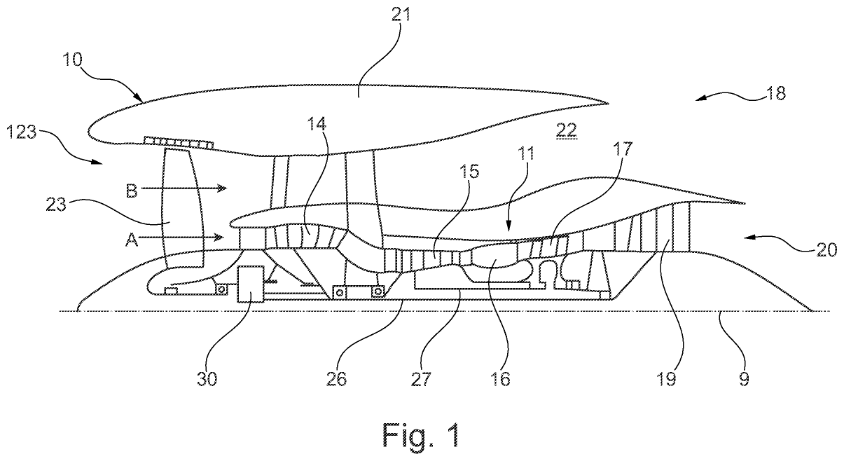

FIG. 1 is a simplified schematic sectional view of a gas turbine engine in which the present invention can be realized;

FIG. 2 is a turbine section of a gas turbine engine which comprises a shaft failure protection system with a first braking element connected to a rotating part of the turbine and a second braking element connected to a static part of the turbine; and

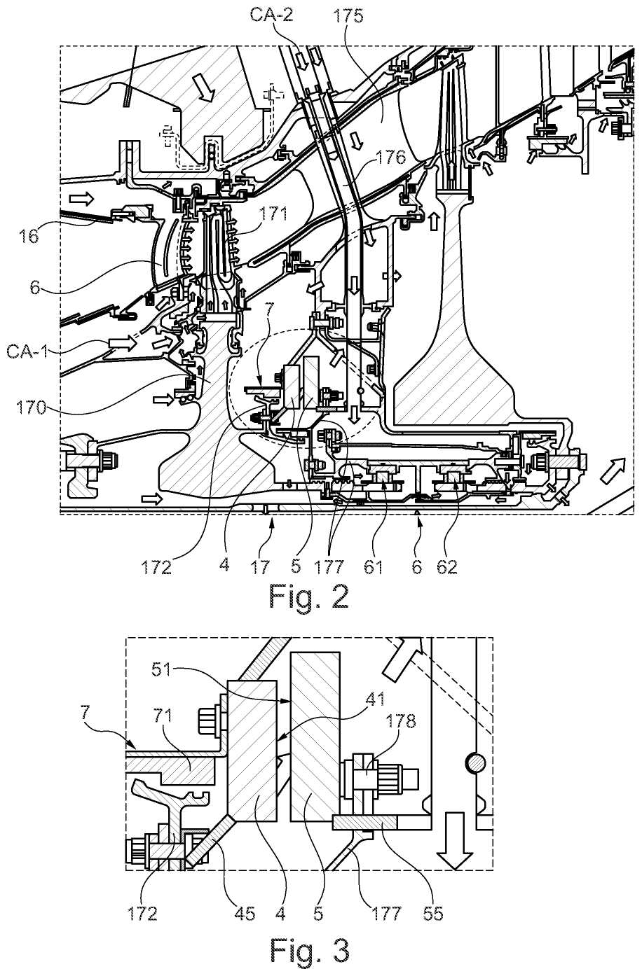

FIG. 3 is an enlarged view of the braking elements of FIG. 2.

FIG. 1 illustrates a gas turbine engine 10 having a principal rotational axis 9. The engine 10 comprises an air intake 12 and a propulsive fan 23 that generates two airflows: a core airflow A and a bypass airflow B. The gas turbine engine 10 comprises a core 11 that receives the core airflow A. The engine core 11 comprises, in axial flow series, a low pressure compressor 14, a high-pressure compressor 15, combustion equipment 16, a high-pressure turbine 17, a low pressure turbine 19 and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a shaft 26 and an epicyclic gearbox 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the nozzle 20 to provide some propulsive thrust. The high pressure turbine 17 drives the high pressure compressor 15 by a suitable interconnecting shaft 27. The fan 23 generally provides the majority of the propulsive thrust. The epicyclic gearbox 30 is a reduction gearbox.

Note that the terms “low pressure turbine” and “low pressure compressor” as used herein may be taken to mean the lowest pressure turbine stages and lowest pressure compressor stages (i.e., not including the fan 23) respectively and/or the turbine and compressor stages that are connected together by the interconnecting shaft 26 with the lowest rotational speed in the engine (i.e., not including the gearbox output shaft that drives the fan 23). In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

Other gas turbine engines to which the present disclosure may be applied may have alternative configurations. For example, such engines may have an alternative number of compressors and/or turbines and/or an alternative number of interconnecting shafts. By way of further example, the gas turbine engine shown in FIG. 1 has a split flow nozzle 20, 22 meaning that the flow through the bypass duct 22 has its own nozzle that is separate to and radially outside the core engine nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area. Whilst the described example relates to a turbofan engine, the disclosure may apply, for example, to any type of gas turbine engine, such as an open rotor (in which the fan stage is not surrounded by a nacelle) or turboprop engine, for example. In some arrangements, the gas turbine engine 10 may not comprise a gearbox 30.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view). The axial, radial and circumferential directions are mutually perpendicular.

In both the high-pressure turbine 17 and the low pressure turbine 19 of the gas turbine engine 10, the turbine 17, 19 comprises at least one rotating part and at least one static part. The rotating part includes a rotating disc to which individual turbine blades are connected. The static part includes a stator that comprises turbine vanes.

In a gas turbine engine 10 as discussed with respect to FIG. 1, or in any other gas turbine engine, a shaft failure protection system may be implemented to limit the rotational speed of the rotating turbine disc by frictional forces in case of a shaft failure.

FIGS. 2 and 3 show an embodiment of such shaft failure protection system. The shaft failure protection system is implemented in a turbine of the gas turbine engine. In the embodiment depicted, the shaft failure protection system is implemented in the high-pressure turbine 17 of the gas turbine engine. FIG. 2 depicts a combustor 16 and nozzle guide vanes 6 located downstream of the combustor 16. The nozzle guide vanes 6 direct the gas flow from the combustor 16 onto turbine blades 171 which are connected to the outer rim of a rotor disc 170. The rotor disc 170 and the turbine blades 171 form a rotor of the high-pressure turbine 17. On passing through the nozzle guide vanes 16, gases from the combustor 16 are given a swirl in the direction of the rotation of the turbine rotor blades 171. The turbine rotor blades 171 receive a force from the gas flow which causes the turbine disc 170 to rotate at a high speed.

The turbine 17 further comprises a static part. The static part includes stator vanes 175 located in the gas path downstream of the rotor blades 171. The static part further includes structural components such as walls 177 which form the static part of a rear bearing arrangement 6 which includes two roller bearings 61, 62 that constrain movement of the shaft in the radial direction but do not constrain movement of the shaft in the axial direction. Static parts 177 may be coupled to a casing of the turbine 17.

In FIG. 2, there are further depicted flows of cooling air. For example, cooling air CA-1 is received from the high-pressure compressor and serves to cool the rotor disc 170 and the turbine blades 171. Cooling air CA-2 is received from the high-pressure compressor and/or the low-pressure compressor and serves to seal lubrication oil within the bearings 61, 62. To this end, cooling air CA-2 is led through a pipe 176 against the radial direction to the rear bearing arrangement 6. The cooling air is part of a secondary air system. Functions of the secondary air systems are, among others, cooling, sealing of oil cavities, sealing of the main gas path, and bearing load management.

A seal 7 is provided between the rotating part and the static part of the turbine 70. As shown in FIG. 3, the seal 7 comprises a static sealing element structure 71 connected to the static part of the turbine and a rotating sealing element structure 172 connected to the rotor disc 170.

The system further comprises two braking elements 4, 5. The first braking element 4 is connected to the rotating sealing element structure 172 by means of a connection 45 which is depicted schematically in FIG. 3. The second braking element 5 is connected to walls 177 of the static part which are coupled to the bearing structure 6. The connection of the second braking element 5 to walls 177 is provided by means of a connection 55 which is depicted schematically in FIG. 3.

FIG. 3 further depicts a flange connection 178 connecting static wall elements.

Under normal operation, as shown in FIGS. 2 and 3, the first braking element 4 and the second braking element 5 are arranged at an axial distance. However, in case of a shaft failure, the rotor disc 170 becomes axially displaced in the downstream direction such that the first braking element 4 and the second braking element 5 get into contact.

As shown in FIG. 3, in such case, the respective surfaces 41, 51 of the first and second braking elements 4, 5 form mating surfaces which get into contact, thereby creating frictional forces which reduce the rotational speed of the rotor disc 170, keeping the rotor disc 170 below the maximum permissible speed (terminal speed) and thereby preventing an otherwise possible braking of the rotor disc 170.

Both braking elements 4, 5 are in the form of a circumferential ring such that the surfaces 41, 51 which get into contact have a large surface area.

The surfaces 41, 51 are flat and arranged parallel to each other in the depicted embodiment. However, other corresponding forms of the surfaces 41, 51 may be implemented, such as a concave surface 41 of the first braking element 4 and a convex surface 51 of the second braking element or vice versa.

It is pointed out that the radial distance of the position of the braking elements 4, 5 from the main axis 9 (see FIG. 1) influences the resultant braking torque, as the braking torque is the force acting between the respective contact areas of the braking elements 4, 5 times the radial distance from the rotational axis.

This further means that the braking torque further depends on the size of the contact area between the braking elements 4, 5 as the size of this contact area determines the force acting between the braking elements 4, 5.

In view of this, a higher braking torque can be achieved when placing the braking elements at a larger distance from the main axis and having a large contact area. At the same time, larger contact areas lead to an increased weight of the braking elements. It is a design task to select the radius such that the braking power is sufficiently high while minimizing the weight of the braking elements.

The first braking element 4 consists of a first friction material and the second braking element 5 consists of a second friction material. Both friction materials consist of or comprise a carbon-silica composite such as carbon fibre reinforced silicon carbide (C/SiC) or a carbon-fibre-reinforced carbon (C/C). For example, the friction material of both braking elements 4, 5 is a carbon fiber reinforced silicon carbide (C/SiC). The first braking element 4 and the second braking element 5 may consist of the identical friction material.

Both carbon fibre reinforced silicon carbide (C/SiC) and carbon-fibre-reinforced carbon have a high coefficient of kinetic friction in the relevant temperature range between 500° C. and 1300° C., the coefficient of kinetic friction being in the range between 0.15 and 0.8. Carbon-fibre-reinforced carbon (C/C) is a composite material consisting of carbon fibre reinforcement in a matrix of graphite. Carbon fibre reinforced silicon carbide (C/SiC) is a composite made of a silicon carbide matrix with carbon fibre reinforcement. Both materials are well described in the scientific literature.

The friction material of the braking elements 4, 5 has material properties such that the coefficient of kinetic friction between the first braking element 4 and the second braking element 5 is higher than the coefficient of kinetic friction in a metal-to-metal contact (which would occur between the rotating part and static part of the turbine 17 without the braking elements 4, 5). In embodiments, the coefficient of kinetic friction lies in the range between 0.15 and 0.8, in particular in the range between 0.4 and 0.6. This coefficient of kinetic friction is present at the operating temperature of the turbine, which may be in the range between 500° C. and 1300° C.

To increase the frictional forces between the first braking element 4 and the second braking element 5, the surfaces 41, 51 of the braking elements 4, 5 may have experienced a surface treatment that increases the roughness of the surfaces 41, 51. In such case, the roughness of the surfaces 41, 51 of the braking elements may be higher than with other of the surfaces of the braking elements 4, 5.

The shaft failure protection system may comprise further components such as an automatic fuel shut off once a shaft failure occurs as known to the skilled person.

It should be understood that the above description is intended for illustrative purposes only, and is not intended to limit the scope of the present disclosure in any way. For example, the location of the first braking element 4 and the second braking element 5 within the turbine 17 may be different and the form of the first braking element 4 and of the second braking element 5 may be different than depicted in the embodiment of FIGS. 2 and 3.

Also, those skilled in the art will appreciate that other aspects of the disclosure can be obtained from a study of the drawings, the disclosure and the appended claims. All methods described herein can be performed in any suitable order unless otherwise indicated herein or otherwise clearly contradicted by context. Various features of the various embodiments disclosed herein can be combined in different combinations to create new embodiments within the scope of the present disclosure. In particular, the disclosure extends to and includes all combinations and sub-combinations of one or more features described herein. Any ranges given herein include any and all specific values within the range and any and all sub-ranges within the given range.

1. A shaft failure protection system comprising:
an engine core comprising a turbine, a compressor, and a shaft connecting the turbine and the compressor;
a first braking element connected to a rotating part of the turbine;
a second braking element connected to a static part of the turbine;
wherein the first braking element and the second braking element are arranged at an axial distance under normal operating conditions and configured to contact each other in case of a failure of the shaft and an associated axial displacement of the rotating part of turbine,
wherein
the first braking element comprises a first friction material and the second braking element comprises a second friction material, wherein the first friction material and the second friction material each comprise a carbon-silica composite or a carbon-fibre-reinforced carbon;
wherein, in case of a failure of the shaft and an associated axial displacement of the rotating part of the turbine, the first friction material and the second friction material contact each other to reduce rotational speed of the rotating part of the turbine by frictional forces.

2. The system of claim 1, wherein the first friction material and the second friction material each comprise a carbon-silica composite, wherein the carbon-silica composite is a carbon fibre reinforced silicon carbide, wherein carbon fibres are integrated in a silicon carbide (SiC) matrix.

3. The system of claim 1, wherein the first friction material and the second friction material are chosen such that the coefficient of kinetic friction between these materials is in the range between 0.15 and 0.8 at the operating temperature.

4. The system of claim 3, wherein the first friction material and the second friction material are chosen such that the coefficient of kinetic friction between these materials is in the range between 0.4 and 0.6 at the operating temperature.

5. The system of claim 3, wherein the operating temperature is 500° C.

6. The system of claim 3, wherein the operating temperature is 1300° C.

7. The system of claim 1, wherein the first friction material and the second friction material are identical.

8. The system of claim 1, wherein rotating part of the turbine is a rotor disc, wherein the first braking element is connected to a sealing element structure coupled to the rotor disc.

9. The system of claim 1, wherein the static part of the turbine to which the second braking element is connected is coupled to a bearing structure for the shaft.

10. The system of claim 1, wherein the first and second braking elements each comprise a surface, the surfaces contacting each other in case of a shaft failure.

11. The system of claim 10, wherein the surface is a flat surface.

12. The system of claim 10, wherein the surface of the first braking element and/or the surface of the second braking element which contact each other in case of a shaft failure have undergone a surface treatment that has increased the roughness of the surface.

13. The system of claim 1, wherein the first braking element and/or the second braking elements is in the form of a ring.

14. The system of claim 1, wherein the turbine is a high pressure turbine of the engine core.

15. A gas turbine engine for an aircraft comprising a system in accordance with claim 1.
